(19) United States
(12) Patent Application Publication
(10) Pub. No.: US 2011/0174192 A1
(43) Pub. Date: Jul. 21, 2011

(54) SUGAR MICRO/NANOFOAMS

(75) Inventors: Reinhard Strey, Dormagen (DE); Michael Klostermann, Koeln (DE); Lorenz Kramer, Koeln (DE); Regina Schwering, Euskirchen (DE); Thomas Sottmann, Koeln (DE)

(73) Assignee: Universitaet Zu Koeln, Koeln (DE)

(21) Appl. No.: 13/054,138

(22) PCT Filed: Jul. 16, 2009
(86) PCT No.: PCT/EP2009/059183

§ 371 Date: Feb. 28, 2011

(30) Foreign Application Priority Data
Jul. 17, 2008 (DE) 10 2008 033 583.5

(51) Int. Cl. C09D 105/00

(52) U.S. Cl. 106/217.7

(57) ABSTRACT

A method for producing rigid sugar micro-/nanofoams includes providing a solution with at least one sugar, a super- or near-critical fluid and a surfactant component as a (micro)emulsion. The (micro)emulsion is expanded so as to convert the super- or near-critical fluid from a state of liquid-like density to a state of gaseous density so as to thereby obtain a micro-/nanofoam. The micro-/nanofoam is then rigidified so as to obtain a rigid sugar micro-/nanofoam.

### CROSS REFERENCE TO PRIOR APPLICATIONS

This application is a U.S. National Phase application under 35 U.S.C. §371 of International Application No. PCT/EP2009/059183, filed on Jul. 16, 2009 and which claims benefit to German Patent Application No. 10 2008 033 583.5, filed on Jul. 17, 2008. The International Application was published in German on Jan. 21, 2010 as WO 2010/007141 A1 under PCT Article 21(2).

### FIELD

The present invention relates to a method for producing sugar micro-/nanofoams, the sugar micro-/nanofoams produced thereby and use thereof as nutrients and medicaments.

### BACKGROUND

In the production of conventional foams, a blowing agent is generally used. This blowing agent is mixed under pressure with the liquid polymer that is to be foamed or with the monomer mixture which is being polymerized, or it is formed by a chemical reaction. The mixture foams by a pressure release of the system, appropriate temperature elevation or reaction. The foam is rigidified by subsequent lowering of the temperature or crosslinking the monomers. The resultant foams are generally macrocellular since an uncontrolled nucleation, growth and aging of the bubbles of the blowing agent always takes place.

The use of microemulsions is known. In this case, water and oil are brought into a macroscopically homogeneous, thermodynamically stable, nanometer-finely structured dispersion by means of a surfactant. The most varied structures can be established by means of the targeted choice of composition, pressure and temperature. For instance, in oil-in-water (O/W) microemulsions, the oil is present in the form of nanometer-size oil droplets which are encased by a surfactant film. The oil, generally a condensed hydrocarbon, can also be replaced by short-chain hydrocarbons such as ethane, propane etc., or by CO₂. Recent literature in particular describes the reverse structured water-in-oil or water-in-CO₂ microemulsions. The aqueous component is used there as an internal phase and the supercritical fluid as an external phase.

Microemulsions of nonaqueous, polar components have also recently been described.

DE 102 60 815 A1 and WO 04/058386 describe the production of nanofoams by the Principle Of Supercritical Microemulsion Expansion (POSME). FIG. 1 illustrates the principle. The first important step of POSME is to produce microemulsions containing supercritical fluids as an internal phase. The second step (step 2), which POSME claims as an inventive step, is that, by pressure release, the microemulsion droplets are expanded in a controlled manner. In this manner, the extremely high number of fluid droplets known for microemulsions is converted into an equally high number of bubbles. The number densities are on the order of magnitude of N=10¹⁶ cm⁻³ and the bubble diameter is 100 nm. It was thereby possible for the first time to achieve a nanofoam having a preset number density. The third step of subsequently rigidifying the foam remained open.

The object of the present invention and the purpose of current technical research and development is to generate and rigidify microcellular or, better still, nanocellular foams. The potential fields of application of such rigid micro- and nanocellular foams are thermal insulation of houses, refrigerators and anywhere where a substantial reduction of the insulation layer thickness is required. The semiconductor and computer manufacturing industry is waiting for nanofoams for electrically insulating circuits which are continually decreasing in size. For thermal insulation, the foam should, for example, be able to be generated in large blocks (bulk material). A further application may be found in the production of optoelectronic components where interest centers on thin perforated transport layers of nanocellular foam. Conventional foamed plastic typically contains 10³ to 10⁶ bubbles per cm³.

The first technical problem is to increase the bubble density to 10¹² cm⁻³ for microcellular foams and 10¹⁸ cm⁻³ for nanocellular foams. One reason for the low number densities in conventional foamed plastics is an uncontrolled nucleation processes. Generally, the details of these nucleation processes in industrial applications are little known and difficult to control. High variability of the product with respect to homogeneity and properties of the foam frequently occurs. Attempts are made to initiate heterogeneous nucleation by adding particles, however, even then bubble sizes below one micrometer cannot be achieved without using very high pressures. It is therefore difficult to achieve high number densities of bubbles. There is also the fact that the heterogeneous particles remain in the end product. Homogeneous nucleation can in principle generate high number densities, but is dependent on extremely high pressures and the exact control thereof. A functioning foam process that is detectably based on homogeneous nucleation has not to date been described. Although the foams produced by POSME are free from the disadvantages of the foam methods previously used in industry, the nanofoam is not stable.

### SUMMARY

An aspect of the present invention is to provide a technically practicable method to generate a stable nanocellular foam which is free from the abovementioned problems. An alternative aspect of the present invention is to keep, in a controllable manner, the number density of the bubbles between 10¹² cm⁻³ and 10¹⁸ cm⁻³ and the median diameter between 10 nm and 100 μm in the stable foam.

In an embodiment, the present invention provides a method for producing rigid sugar micro-/nanofoams which includes providing a solution with at least one sugar, a super- or near-critical fluid and a surfactant component as a (micro)emulsion. The (micro)emulsion is expanded so as to convert the super- or near-critical fluid from a state of liquid-like density to a state of gaseous density so as to thereby obtain a micro-/nanofoam. The micro-/nanofoam is then rigidified so as to obtain a rigid sugar micro-/nanofoam.

### BRIEF DESCRIPTION OF THE DRAWINGS

The present invention is described in greater detail below on the basis of embodiments and of the drawings in which:

FIG. 1 shows a sketch of POSME: Micelles in water overlayered with gaseous CO₂, at a standard pressure of 1 bar (left); microemulsion of supercritical CO₂ in water (center) and by expansion a nanofoam forms, each microemulsion droplet becomes a nanofoam bubble (right);

FIG. 2 shows T-γ intersections of the system H₂O/sucrose/trehalose-n-hexane-Lutensol® XL70/Agnique® PG 8105-G. By increasing the sugar content in the hydrophilic subphase, the phase boundaries shift to lower temperatures. This effect can be compensate by using the hydrophilic surfactant Agnique® PG 8105-G, however, the phase boundaries then shift to a higher γ;

FIG. 3 shows T-γ intersections for the system H₂O/sucrose/trehalose-oil-Lutensol® XL 70/Agnique® PG 8105-G. Owing to the change to propane, the phase boundaries shift to a higher γ. In addition, the single-phase region expands. The lower phase limit of the system containing propane can only be estimated because the system is highly viscous at these low temperatures;

FIG. 4 shows T-y intersections for the system H₂O/sucrose/trehalose-propane-Lutensol® XL 70/Agnique® PG 8105-G depending on the volume fraction φ of propane in the mixture of propane and hydrophilic component. By decreasing propane, the phase boundaries shift to lower surfactant mass fractions γ and to lower temperatures. The phase behavior of the microemulsion used in the example corresponds to that at φ=0.098;

FIG. 5 shows a pressure-resistant observation cell;

FIGS. 6-10 show images of the micro-/nanofoams produced in Example 1. It may be seen that the pore size of the foams lies in the mid-micrometer range;

FIG. 11 shows an image of the sugar micro-/nanofoam produced in Example 2 which has pore sizes in the lower micrometer range;

FIG. 12 shows an image of the sugar micro-/nanofoam produced in Example 3. It may be seen that this foam has a monodisperse foam structure having pore sizes in the range of 3-5 micrometers; and

FIG. 13 shows an image of the edible sugar micro-/nanofoam produced in Example 4.

### DETAILED DESCRIPTION

A method has now been found which enables the production of rigidifiable sugar nanofoams and which may be of fundamental importance for producing rigidifiable nanofoams by POSME. The present invention provides a process of rigidifying nanofoams by using sugar (such as sucrose). According to the present invention, the nanofoam is rigidified by using a nanostructured, homogeneous, single-phase high-viscosity microemulsion having a high proportion of sugar in the hydrophilic phase. The microemulsion droplets in this case contain a nonpolar, super- or near-critical component (a “blowing agent” such as CO₂, ethane, propane or N₂O) and the external phase consists of a highly concentrated aqueous sugar solution. In a second step, it is possible to expand the droplets to form small bubbles without nucleation, since the energy for forming the gas phase is low or is in the order of magnitude of kT. The foam webs and lamellae are rigidified by the high-viscosity sugar solution which converts into a vitreous solid state with an appropriate fall in temperature. The sugar foams produced in this manner, which foams are distinguished by a high surface area to unit volume ratio, have potential applications in the most varied sectors. By chemically modifying the sugar molecules at the foam surface, the synthesis of functional “high-surface-area” materials is possible, which materials can be used, for example as surface catalysts, in chemical processing. By means of subsequent treatment of the foams to protect them from moisture etc. (carbonizing, welding into film), the foams can additionally be used as materials in technical applications (such as in highly insulating materials). In addition, by using biocompatible or edible surfactants, use of the sugar foams in biological, medical or food applications is possible. For instance, appropriate sugar foams can be used in biological or medical applications as carrier materials for surface processes, and also the controlled release of active ingredients (such as in sticking plasters or carrier films). In the food industry, edible sugar foams may be used as base substances for confectionery, or else for preparing sweeteners. Owing to their particular optical properties, sugar micro-/nanofoams can additionally be used as edible packaging materials. The present invention therefore relates to:

(1) A method for producing rigid sugar micro-/nanofoams which comprises
(a) providing a (micro)emulsion comprising a solution of a sugar component (K1), a super- or near-critical fluid (K2) and a surfactant component (K3),
(b) expanding the (micro)emulsion obtained in (a), wherein the super- or near-critical fluid converts from the state of liquid-like density to the state of gaseous density, obtaining a micro-/nanofoam and (simultaneously or subsequently) rigidifying the micro-/nanofoam;
   (2) a rigid sugar micro-/nanofoam obtainable by the method of (1) which, for example, has a pore size of 10 nm to 100 μm;
   (3) a high-surface-area material which is obtainable from a sugar micro-/nanofoam of (2) by (surface) modification;
   (4) a material which is based on a sugar micro-/nanofoam of (2);
   (5) a carrier material for biological and medical applications which contains a rigid sugar micro-/nanofoam of (2); and
   (6) a nutrient or medicament containing the rigid sugar micro-/nanofoam of (2).

In an embodiment of the method of the present invention, a single-phase, homogeneous, nanostructured, high-viscosity, sugar-containing microemulsion is used which, after the course of the expansion in step (b), converts into a micro-/nanoporous, solid sugar foam. In this case, the internal phase contains a supercritical or near-critical fluid which acts as a blowing agent, and the external phase contains a highly concentrated aqueous sugar solution. The solidification (rigidification, setting) of the foam proceeds by lowering the temperature below the glass temperature of the sugar solution. A stable rigidification of the sugar micro-/nanofoam is thereby achieved.

In an embodiment of the method of the present invention, K1 is a (concentrated homogeneous) solution of one or more sugars in a solvent, in particular in water, or a polar or volatile solvent. The solvent can, for example, be water and the sugar can, for example, be selected from glucose, fructose, sucrose, trehalose and mixtures thereof. Further sugar compounds which can be used in the method according to the present invention are sugar substitutes (such as, for example, sorbitol, xylitol, erythritol etc.), higher polymers of said sugar compounds (such as, for example, starch, cellulose, derivatives of same etc.) and other compounds which exhibit a similar setting behavior to sugar.

In an embodiment of the method of the present invention, in K2, the super- or near-critical fluid is selected from CO₂, ethane, propane, N₂O, fluorinated hydrocarbons and mixtures thereof. It can, for example, be CO₂ or propane. If necessary, the super- or near-critical fluid can be dissolved in a liquid, wherein the liquid can, for example, be selected from the group of the medium-chain alkanes. Examples include pentane, cyclopentane, hexane, cyclohexane etc. The super- or near-critical fluid can, for example, be present in droplets having a diameter of 3 nm to 1000 nm, for example, 5 nm to 50 nm.

In an embodiment of the method of the present invention, K3 can comprise one or more surfactants selected from the group of nonionic, ionic or amphoteric surfactants, and also amphiphilic block copolymers. Examples include hydrophilic surfactants such as alkyl (such as Agnique PG-264) and alkenyl oligoglycosides, hydrophilic alkyl polyglycol ethers (such as Lutensol XL70), monoglycerides, edible fatty acid esters and mixtures of same.

In an embodiment of the method of the present invention,

the content of sugar in the (micro)emulsion is 30 to 100% by weight, for example, 60 to 95 or 60 to 85% by weight; and/or

the content of the super- or near-critical fluid in the (micro)emulsion is 1 to 60% by weight, for example, 2 to 15% by weight; and/or

the content of surfactants in the (micro)emulsion is 1 to 40% by weight, for example 5 to 20% by weight.

In an embodiment of the method of the present invention, the (micro)emulsion can be provided in step (a) at a pressure of 20 to 500 bar, for example, 50 to 250 bar.

For controlling the pore size of the sugar micro-/nanofoam, the (micro)emulsion can be expanded in step (b) against a counterpressure. When a counterpressure is applied, the pore size of the sugar micro-/nanofoam decreases. A suitable counterpressure can, for example, be in the range from 50 to 0.1 bar, for example, 20 to 1 bar.

The present invention will hereinafter be described (by way of example and without limiting generality) in relation to the production of nanofoams by POSME. For this purpose, a microemulsion of supercritical CO₂ in water is first prepared with addition of a nonionic surfactant such as Lutensol® XL 70. For this purpose, 1 cm³ of a micellar water-Lutensol® XL 70 surfactant solution is brought into contact at p=1 bar and T=40° C. with 30 cm³ of gaseous CO₂. Then, by increasing the pressure to p=220 bar, a water-CO₂-Lutensol® XL 70 microemulsion is generated having a volume fraction of liquid CO₂ of φₒ=0.1. If the CO₂ pools in the microemulsion droplets are to have a diameter of 2r=10 nm, in the water-Lutensol® XL 70 starting solution the surfactant volume fraction required is φₛ=0.075. This microemulsion of supercritical CO₂ has a number density of N=2·10¹⁷ cm⁻³. The CO₂ microemulsified therein has a fluid density of 8.6·10² kg m⁻³. Subsequent to the microemulsion formation, a continuous expansion by pressure reduction follows. It is characteristic of POSME that no nucleation step is necessary, since the microemulsion droplets can follow each infinitesimal pressure change immediately by adaptation of volume. Each microemulsion droplet becomes a bubble in the course of the expansion. Seen from the outside, in the course of the expansion process, 30 cm³ of foam form from 1 cm³ of microemulsion. Owing to the expansion to p=1 bar, the gas density of the droplets falls to 1.76 kg m⁻³. In the water-CO₂-Lutensol® XL 70 example, CO₂ gas bubbles of 2r=60 nm diameter are formed. These gas bubbles form a dense foam in which the gas occupies a volume fraction of 75%, i.e. φ=0.75. Correspondingly, the number density falls to N=7·10¹⁵ cm⁻³, but thereby remains in the range of the sought-after nanofoam.

Rigidification of the microemulsion proceeds after the second step of POSME. According to the present invention, the use of hydrophilic sugars (such as sucrose, trehalose etc.) can be used therefor. Dissolving sugar in the polar component has two effects in this case: Firstly, the addition increases the viscosity of the system which leads to a retarded reorganization kinetics of the microemulsion. During the expansion of the system, a greater yield of microstructure is thereby possible. Secondly, the expansion of the system can achieve a vitreous state, whereby the rigidification of the nanofoam would be achieved.

The quantities used are hereinafter defined. The three individual components of the microemulsion system are abbreviated for simplification using the following letters:

A=polar component (water)

B=nonpolar component (oil)

C=surfactant

For characterization of microemulsions, the following variables are used: the mass fraction (α) of the oil on the basis of the mixture of polar component and oil is given by:

$$α = \frac{{m}_{B}}{{m}_{A} + {m}_{B}} .$$

A further important quantity is the mass fraction γ of surfactant for the entire mixture:

$$γ = \frac{{m}_{C}}{{m}_{A} + {m}_{B} + {m}_{C}} .$$

For simplification of systems having more than three components, each further component is summarized together with the main component which most resembles it to form a pseudo component, here the sugar as a hydrophilic component to component A. This gives the total mass of polar component as:

m′_{A}=m_{H}_{₂}_{O}+m_{Sugar}.

If a mixture of the surfactants C, D is used, this gives the mass of amphiphilic component as:

m′_{C}=m_{C}+m_{D}.

Correspondingly for the surfactant i in the surfactant mixture, the mass fraction is given by:

$${δ}_{i} = \frac{{m}_{i}}{{m}_{C}^{′}} .$$

The following applies for the mass fraction of sugar of the total mass of the polar component:

$${Ψ}_{Sugar} = \frac{{m}_{Sugar}}{{m}_{A}^{′}} .$$

The effect of sugars on the phase behavior of microemulsions at atmospheric pressure is the subject of current research. Studies to date show that the addition of sugar has a marked effect on the phase behavior of microemulsions.

H₂O/sucrose/trehalose-n-hexane-nonionic surfactant

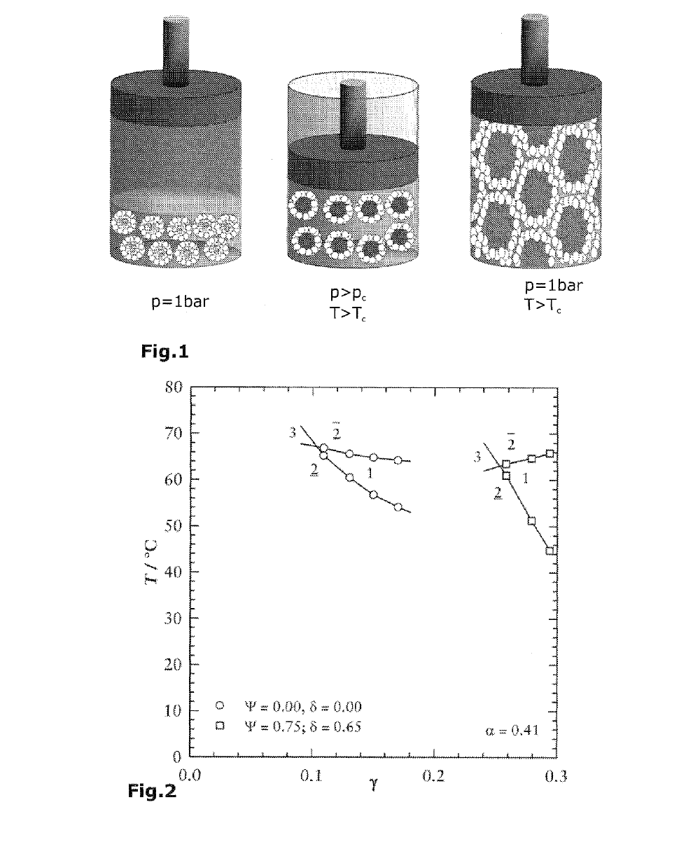

The starting system used is H₂O-n-hexane-Lutensol® XL 70 at an oil mass fraction of α=0.41. The studies found that by increasing the content of sugar Ψ in the polar component, the phase boundaries of the system shift strongly to lower temperatures. In order to compensate for this effect, a surfactant mixture of Lutensol® XL 70 and the very hydrophilic sugar surfactant Agnique® PG 8105-G is used. As can be seen in FIG. 2, it is possible, in the system H₂O/sucrose/trehalose-n-hexane-Lutensol® XL 70/Agnique® PG 8105-G, to set a microemulsion having a sugar content of Ψ=0.75 in the hydrophilic phase. The first aspect is thus achieved. However, the n-hexane should now be exchanged for a supercritical or near-critical fluid.

H₂O/sucrose/trehalose-propane-nonionic surfactant

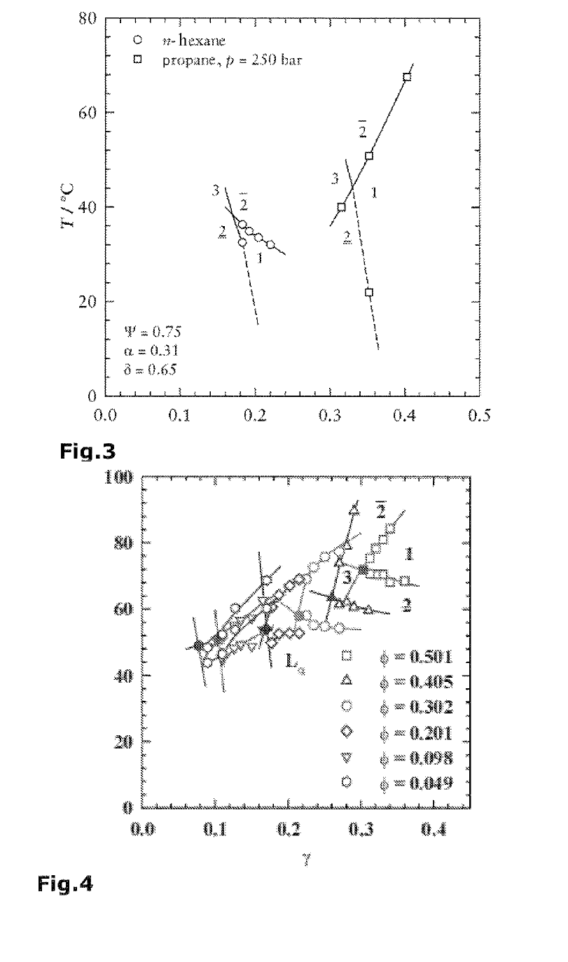

The critical temperature of n-hexane is T_{c}=234.2° C. and is therefore 134° C. above the boiling temperature of water. n-hexane is therefore not particularly suitable for use as a supercritical fluid in an aqueous microemulsion. However, propane can be considered as a near-critical fluid. Therefore, in the system H₂O/sucrose/trehalose-oil-Lutensol® XL 70/Agnique® PG8105-G, the n-hexane is replaced by propane at Ψ=0.75, δ=0.65 and α=0.31. In this case, the system containing propane is kept at a pressure of p=250 bar. As FIG. 3 shows, the range of the single-phase microemulsion shifts to a higher y, but only to slightly higher temperatures.

The reduction in efficiency may be explained by the poor interaction of the surfactant molecules with propane. The interaction is greatly decreased by the low density of propane; the hydrophobic surfactant tails can only penetrate the oil poorly. In addition, solubilization effects cause an increase of the amount of surfactant mixture required, since some of the nonionic surfactant monomer dissolves in propane. It is nonetheless possible to produce a single-phase microemulsion in the system H₂O/sucrose/trehalose-propane-Lutensol® XL 70/Agnique® PG8105-G at a pressure of p=250 bar and α=0.31, δ=0.65 and Ψ=0.75.

By increasing the content of sugar surfactant Agnique® PG8105-G in the surfactant mixture to 6=0.9, it is possible to vary the volume fraction φ of propane in the mixture of propane and hydrophilic component. In this case, the fraction Ψ=0.75 of the sugar was kept constant and the pressure was kept constant at p=250 bar. FIG. 4 shows the respective T-γ intersections. It can be seen that the phase boundaries shift by the decrease in propane to lower surfactant mass fractions γ and to lower temperatures. The phase behavior of the microemulsion used in the example corresponds to that at φ=0.098.

The studies confirm that it is possible to produce a high-viscosity, near-critical microemulsion which is suitable for preparing stable sugar nanofoams.

It is clear to those skilled in the art that the figures and substances given in this example can be varied over wide ranges. For example, the bubble diameter, by targeted setting of composition, temperature and expansion deepness, can be in the range from 0.01<2r/μm<100 and the volume fraction of the bubbles can be 0.1<φ<0.99. The external phase can comprise water, polar solvents (such as glycerol, formamide, dimethyl sulfoxide (DMSO), sulfolane etc.), volatile solvents (such as methanol, ethanol, acetone, diethyl ether etc.) and also the whole variety of sugars (such as glucose, fructose, sucrose, trehalose etc.) and mixtures thereof. In the droplets comprising CO₂, ethane, propane, N₂O, fluorinated hydrocarbons or other near-critical fluids and the mixtures thereof, auxiliary substances can be dissolved in order to cover the enlarging interfacial area and in order to keep the interfacial tension low. The surfactants can be mixtures of nonionic, ionic or amphoteric surfactants, and also amphiphilic block copolymers. Fluorinated surfactants or silicone surfactants can also be used, and also the whole variety of surfactants permitted for nutrients and cosmetics.

The method described here for sugar can also be extended to other classes of substance, provided that, analogously to the sugar, firstly they form an expandable (micro)emulsion and secondly, on cooling, convert into a vitreous state. Such substances are hydrophilic polymers, such as polyols, polyethylene glycols etc. and also polar melts in the broadest sense.

The central point of the principle of the present invention is the expansion of preformulated small droplets of a supercritical or near-critical liquid in a homogeneous microemulsion. The number density of the droplets is freely selectable over broad ranges via the adjustable parameters of microemulsions (see above). The fact that the fluid is supercritical or at least near-critical means that the fluid density of each droplet can be adjusted virtually seamlessly to the external pressure.

The parameter temperature is freely selectable in broad ranges.

By the choice of the surfactants/surfactant mixtures and the supercritical fluids/supercritical fluid mixtures, great flexibility exists in the formulation of the microemulsion that is to be foamed, wherein, however, legal restrictions on approval should be taken into account. For instance, for nutrients and medicaments, all of the components K1 to K3 of the system should be permitted for nutrients or medicaments. The resultant foams have bubble diameters in the range of the median free path length of the gas molecules which leads to a marked improvement in heat insulation (Knudsen effect).

The rigidification of a nanofoam by using high-viscosity supercritical or near-critical sugar microemulsions is the subject matter of the present invention and will for the first time make possible preparation of solid nanofoams having a bubble diameter in the nanometer range.

The micro-/nanofoams of the present invention, for the aspects (3) to (6) of the present invention, can be subjected to any desired post-treatment steps in which the surface is treated mechanically or chemically or is loaded with active ingredients. For use as nutrients, other nutrient components can be applied in this case, and for use as medicaments, the micro-/nanofoams of the invention can be loaded with active ingredients.

The present invention will hereinafter be described in more detail with reference to the following examples which should not, however, be considered to restrict the present invention.

### EXAMPLES

### Example 1

### Production of Sugar Foam Having Pore Sizes in the Mid-Micrometer Range

Formulation of a thermodynamically stable macroscopically homogeneous but microscopically structured mixture (microemulsion, see phase diagram in FIG. 4; φ=0.098, δ=0.9, Ψ=0.75) from

w(H₂O)=20.0% by weight

w(sucrose)=37.3% by weight

w(trehalose)=22.9% by weight

w(propane)=3.3% by weight

w(Agnique PG-264)=14.8% by weight

w(Lutensol XL70)=1.7% by weight

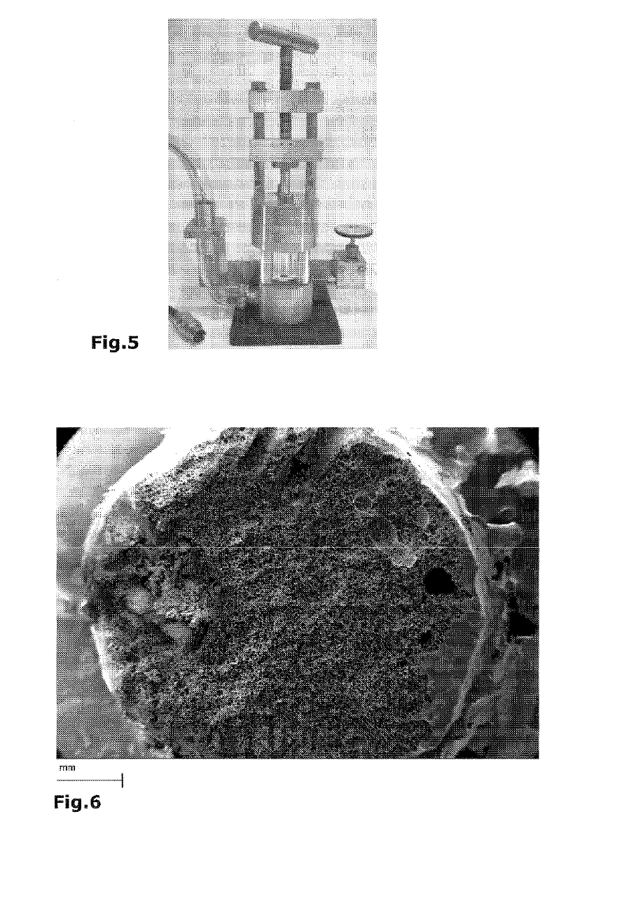

in a pressure-tight observation cell (see FIG. 5) at p=250 bar and T=50° C.

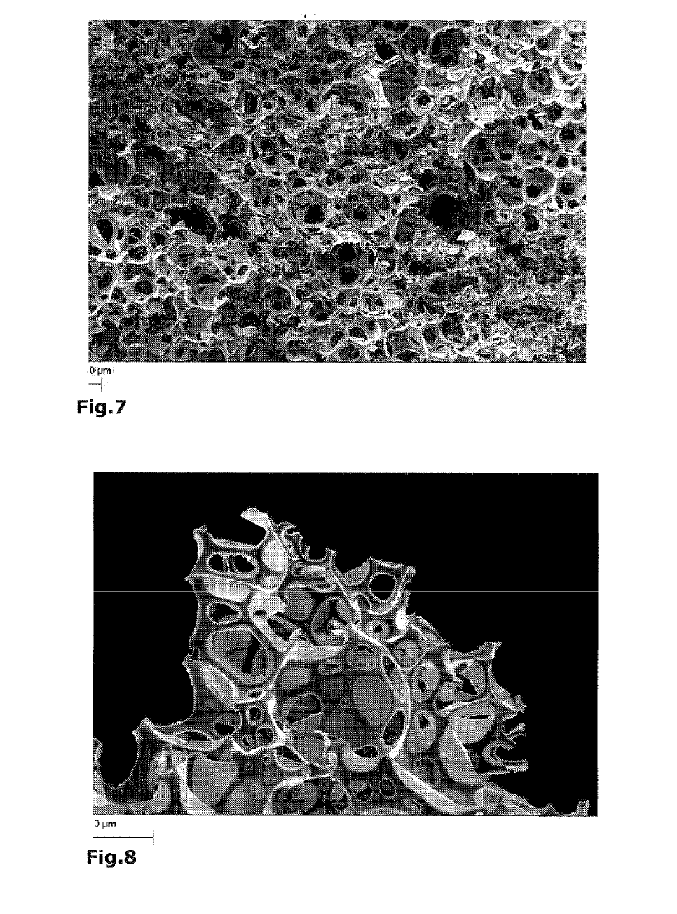

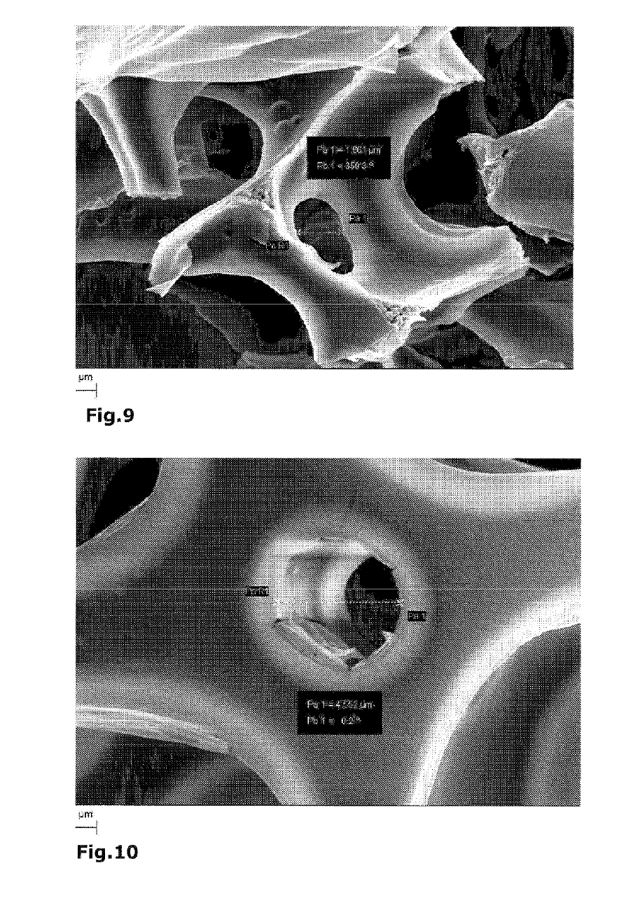

This mixture, starting from p=250 bar and T=50° C., was expanded through a capillary having an internal diameter of d=0.5 mm to atmospheric pressure and T=25° C. In this process, the mixture foams and the foam hardens. Scanning electron micrographs (see FIGS. 6 to 10) verify that the pore sizes are 1-100 micrometers.

Reasons for the hardening could be cooling of the foam from T=50° C. to T<25° C. (adiabatic expansion) and the vaporization of water into the resultant foam pores. Expanding sugar-containing microemulsions against a constant counterpressure offers optimization to smaller pore sizes. In addition, optimization of the foam structure by using more highly concentrated sugar solutions is possible, since corresponding systems solidify more rapidly in the form of sugar glasses (see Example 2). Further optimization of the foam structure is possible by varying the surfactant content, since by means of an increased surfactant content, smaller microemulsion structures are formed, which should subsequently lead to smaller foam structures (see Example 3).

### Example 2

### Production of Sugar Foam Having Pore Sizes in the Lower Micrometer Range

A high-viscosity sugar/surfactant solution in water of

w(H₂O)=6.3% by weight

w(sucrose)=51.9% by weight

w(trehalose)=31.8% by weight

w(Agnique PG 264)=7.5% by weight

w(Agnique PG 8105)=2.5% by weight,

which is nanostructured owing to self-aggregation of the surfactant molecules, was applied to aluminum sample carriers and placed into a pressure-resistant observation cell. The cell was then filled with propane and the pressure and temperature of the system were set to p=250 bar and T=90° C. Owing to its thermodynamic stability, a nano structured microemulsion formed in which the propane was incorporated into the surfactant structures of the sugar/surfactant solution. After an exposure time of one hour, the pressure of the system was expanded to atmospheric pressure at T=90° C., wherein the sugar solution foamed and rapidly solidified. Scanning electron micrographs of the foam (FIG. 11) show that the pore sizes of the foam are approximately 1-10 micrometers.

### Example 3

### Production of Monodispersed Sugar Foam Having Pore Sizes in the Lower Micrometer Range

A high-viscosity sugar/surfactant solution in water of

w(H₂O)=5.6% by weight

w(sucrose)=46.1% by weight

w(trehalose)=28.3% by weight

w(Agnique PG 264)=15.0% by weight

w(Agnique PG 8105)=5.0% by weight

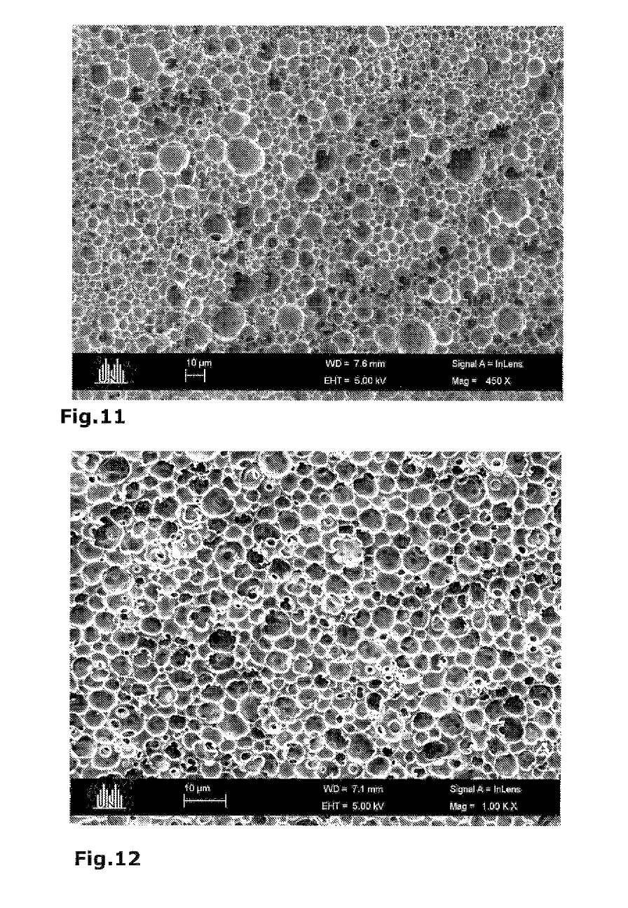

was foamed with propane according to the method described in Example 2 at p=250 bar and T=90° C. Scanning electron micrographs of the sugar foams thus generated verify that highly monodisperse sugar foams having a pore size of approximately 3-5 micrometers can be produced in this manner (FIG. 12).

### Example 4

### Production of Edible Sugar Foam Having Pore Sizes in the Micrometer Range

As per the method described in Example 1, in a pressure-resistant cell, a thermodynamically stable microemulsion of

w(H₂O)=0.185% by weight

w(sucrose)=34.5% by weight

w(trehalose)=21.1% by weight

w(propane)=6.9% by weight

w(Ryoto® Sugar Ester L-1695)=9.0% by weight

w(Tween® 20)=4.3% by weight

w(PGPR, E476)=5.7% by weight

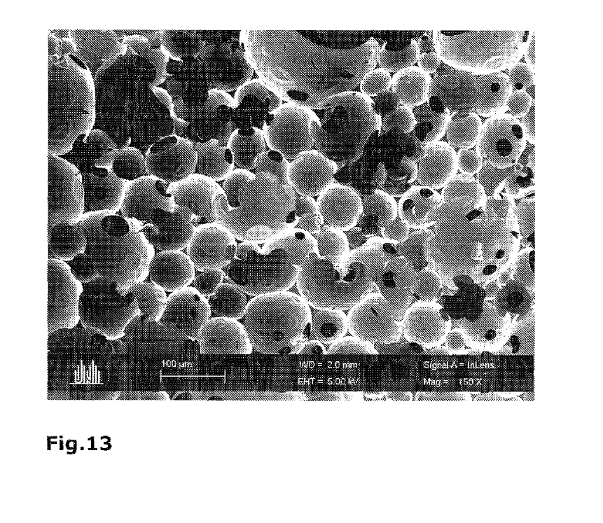

at p=250 bar and T=45° C. was expanded to atmospheric pressure and T=25° C. through a capillary having an internal diameter of d=0.5 mm. Scanning electron micrographs show that the foam is made up of pores in a size range of 20-100 micrometers (FIG. 13). Since the surfactants used for producing this foam are all edible, the foam shown in FIG. 13 is already the first edible sugar micro-/nanofoam which could be used in the food industry.

The present invention is not limited to embodiments described herein; reference should be had to the appended claims.

1-15. (canceled)

16. A method for producing a rigid sugar micro-/nanofoam, the method comprising:
providing a solution with at least one sugar, a super- or near-critical fluid and a surfactant component as a (micro)emulsion;
expanding the (micro)emulsion so as to convert the super- or near-critical fluid from a state of liquid-like density to a state of gaseous density so as to thereby obtain a micro-/nanofoam; and
rigidifying the micro-/nanofoam so as to obtain a rigid sugar micro-/nanofoam.

17. The method as recited in claim 16, wherein the at least one sugar is selected from compounds which form expandable (micro)emulsions and on cooling convert into a vitreous state and which comprise at least one of a hydrophilic polymer and a polar melt.

18. The method as recited in claim 17, wherein the hydrophilic polymer includes at least one of a polyol and a polyethylene glycol.

19. The method as recited in claim 17, wherein the at least one sugar is at least one of a true sugar and a sugar substitute, and polymers and derivatives thereof.

20. The method as recited in claim 19, wherein the true sugar is a glucose, a fructose, a sucrose and a trehalose, the sugar substitute is a sorbitol, a xylitol and an erythritol, and the polymers of the at least one of a true sugar and a sugar substitute include a starch and a cellulose, and derivatives thereof.

21. The method as recited in claim 16, wherein the solution with at least one sugar is at least one sugar in a solvent, a polar solvent or a volatile solvent.

22. The method as recited in claim 21, wherein the polar solvent is water and the sugar is at least one of glucose, fructose, sucrose, trehalose, polymer compounds thereof and sugar substitutes.

23. The method as recited in claim 16, wherein the super- or near-critical fluid is at least one of:
at least one of CO₂, ethane, propane, N₂O, fluorinated hydrocarbons and mixtures thereof, is dissolved in a liquid, and
droplets of the super- or near-critical fluid exist which have a diameter of 3 nm to 1000 nm.

24. The method as recited in claim 23, wherein the liquid is a medium-chain alkane and the diameter is 5 nm to 50 nm.

25. The method as recited in claim 24, wherein the medium chain alkane is at least one of a pentane, a cyclopentane, a hexane and a cyclohexane.

26. The method as recited in claim 16, wherein the surfactant component comprises at least one of a nonionic surfactant, an ionic surfactant, an amphoteric surfactant, an amphiphilic block copolymer, a hydrophilic surfactant such as an alkyl and an alkenyl oligoglycoside, a hydrophilic alkyl polyglycol ether, a monoglyceride and an edible fatty acid ester.

27. The method as recited in claim 16, wherein the (micro)emulsion is comprised of 30 to 98 wt.-% of the solution with at least one sugar, 1 to 60 wt.-% of the super- or near-critical fluid and 1 to 40 wt.-% of the surfactant component.

28. The method as recited in claim 27, wherein the (micro)emulsion is comprised of 60 to 85 wt.-% of the solution with at least one sugar, 2 to 15 wt.-% of the super- or near-critical fluid and 5 to 20 wt.-% of the surfactant component.

29. The method as recited in claim 16, wherein the providing of the (micro)emulsion occurs at a pressure of 20 to 500 bar.

30. The method as recited in claim 29, wherein the pressure is 50 to 250 bar.

31. The method as recited in claim 16, wherein the expanding of the (micro)emulsion occurs against a counterpressure of 50 to 0.1 bar.

32. The method as recited in claim 31, wherein the counterpressure is 20 to 1 bar.

33. A rigid sugar micro-/nanofoam obtainable by:
providing a solution with at least one sugar, a super- or near-critical fluid and a surfactant component as a (micro)emulsion;
expanding the (micro)emulsion so as to convert the super- or near-critical fluid from a state of liquid-like density to a state of gaseous density so as to thereby obtain a micro-/nanofoam; and
rigidifying the micro-/nanofoam so as to obtain the rigid sugar micro-/nanofoam.

34. The rigid sugar micro-/nanofoam as recited in claim 33, wherein the rigid sugar micro-/nanofoam has a pore size of 10 nm to 100 μm.

35. A material which is at least one of based on and contains the sugar micro-/nanofoam as recited in claim 33.

36. The material as recited in claim 35, wherein the material is at least one of a carrier material for biological applications, a carrier material for medical applications, a nutrient, a medicament, a surface catalyst, and an insulating material.
